(19) United States
(12) Patent Application Publication
(10) Pub. No.: US 2023/0345292 A1
(43) Pub. Date: Oct. 26, 2023

(54) DETERMINING AN EXPECTED QOS ADAPTATION PATTERN AT A MOBILE EDGE COMPUTING ENTITY

(71) Applicant: Lenovo (Singapore) Pte. Ltd., New Tech Park (SG)

(72) Inventors: Emmanouil Pateromichelakis, Viersen (DE); Ravi Kuchibhotla, Chicago, IL (US)

(21) Appl. No.: 18/024,363

(22) PCT Filed: Sep. 2, 2020
(86) PCT No.: PCT/EP2020/074490

§ 371 Date: Mar. 2, 2023

(51) Int. Cl. H04W 28/02; H04W 28/12

(52) U.S. Cl. CPC H04W 28/0268; H04W 28/12

(57) ABSTRACT

Apparatuses, methods, and systems are disclosed for edge enabled AI/ML-assisted QoS profile configuration. One method includes receiving at least one of actual and expected characteristics of a user equipment (“UE”) that describes a context of the UE, obtaining a data analytics model describing at least one expected network condition of a radio access network (“RAN”) node based on the characteristics of the UE, determining an expected QoS adaptation pattern, based on the obtained data analytics model, at a mobile edge computing entity within a service area of the UE, the QoS adaptation pattern comprising a sequence of QoS profiles to be associated with a QoS flow for the UE over a time interval, and communicating the expected QoS adaptation pattern for the QoS flow of the UE to the UE and/or at least one network node associated with the QoS flow.

### FIELD

The subject matter disclosed herein relates generally to wireless communications and more particularly relates to edge enabled AI/ML-assisted QoS profile configuration.

### BACKGROUND

The following abbreviations are herewith defined, at least some of which are referred to within the following description: Third Generation Partnership Project (“3GPP”), Fifth Generation Core Network (“5CG”), Fifth Generation System (“5GS”), Fifth Generation QoS Identifiers (“5QI”), Authentication, Authorization and Accounting (“AAA”), Artificial Intelligence (“AI”), Application Function (“AF”), Advanced Intersection Collision Warning (“AICW”), Access and Mobility Management Function (“AMF”), Positive-Acknowledgment (“ACK”), Application Programming Interface (“API”), Access Stratum (“AS”), Base Station (“BS”), Category of Requirements (“CoR”), Command-and-Control (“C2”), Control Element (“CE”), Cooperating merging (“CM”), Cooperative Overtaking (“CO”), Cooperating Transition of Control (“CToC”), Cooperative Lane Change (“CLC”), Collective Perception (“CP”), Collective Perception Message (“CPM”), Core Network (“CN”), Connected and Autonomous Vehicle (“CAV”), Decentralized Environmental Notification Message (“DENM”), Downlink (“DL”), Data Radio Bearer (“DRB”), Discontinuous Transmission (“DTX”), Edge Enabler Client (“EEC”), Edge Configuration Server (“ECS”), Edge Application Server (“EAS”) Evolved Node-B (“eNB”), Evolved Packet Core (“EPC”), Evolved Packet System (“EPS”), Evolved UMTS Terrestrial Radio Access (“E-UTRA”), Evolved UMTS Terrestrial Radio Access Network (“E-UTRAN”), European Telecommunications Standards Institute (“ETSI”), Guaranteed Bit Rate (“GBR”), Guaranteed Flow Bit Rate (“GFBR”), General Packet Radio Service (“GPRS”), Generic Public Service Identifier (“GPSI”), Global System for Mobile Communications (“GSM”), Hybrid Automatic Repeat Request (“HARQ”), Home Subscriber Server (“HSS”), Information Element (“IE”), Internet-of-Things (“IoT”), International Mobile Equipment Identity (“IMEI”), Intelligent Transportation System (“ITS”), ITS Station (“ITS-S”), Infrastructure to Vehicle Information Message (“IVIM”), Key Performance Indicator (“KPI”), Level of Automation (“LoA”), Long Term Evolution (“LTE”), Mobile or Multi-access Edge Computing (“MEC”), Machine Learning (“ML”), Mobility Management (“MM”), Mobility Management Entity (“MME”), Map (topology) Extended Message (“MAPEM”), Maneuver Control (“MC”), Maneuver Control Message (“MCM”), Mean Opinion Score (“MOS”), Negative-Acknowledgment (“NACK”) or (“NAK”), Network Exposure Function (“NEF”), New Generation (5G) Node-B (“gNB”), New Generation Radio Access Network (“NG-RAN”, a RAN used for 5GS networks), New Radio (“NR”, a 5G radio access technology; also referred to as “5G NR”), Non-Access Stratum (“NAS”), Network Slice Selection Assistance Information (“NSSAI”), Overtaking Vehicle Warning (“OVW”), Packet Delay Budget (“PDB”), Packet Error Rate (“PER”), Packet Data Unit (“PDU”, used in connection with ‘PDU Session’), PC5 5QI (“PQI”), Permanent Equipment Identifier (“PEI”), Platoon Control (“PC”), Platoon Control Message (“PCM”), Proximity Service (“ProSe”), Public Land Mobile Network (“PLMN”), QoS Flow Indicator (“QFI”), Quality of Experience (“QoE”), Quality of Service/Experience (“QoS”), Predictive QoS (“P-QoS”), Radio Access Network (“RAN”), Radio Network Information Service (“RNIS”), Radio Resource Control (“RRC”), Receive (“RX”), Road Side Unit (“RSU”), Service Capability Exposure Function (“SCEF”), Service Enabler Architecture Layer (“SEAL”), Service-Level Agreement (“SLA”), Session Management (“SM”), Session Management Function (“SMF”), Service Provider (“SP”), Single Network Slice Selection Assistance Information (“S-NSSAI”), Signal Phase And Timing Extended Message (“SPATEM”), Signal Request Extended Message (“SREM”), Signal request Status Extended Message (“SSEM”), Target Driving Area Reservation (“TDAR”), Transport Block (“TB”), Transmit (“TX”), Vehicle-to-Everything (“V2X”), Vehicle-to-Infrastructure (“V2I”), Vehicle-to-Vehicle (“V2V”), Vehicle-to-Relay (“V2R”), V2X Application Enabler (“VAE”), Vulnerable Road User Protection (“VRUP”), Unified Data Management (“UDM”), Unmanned Aerial System (“UAS”), UAS Application Enabler (“UAE”, i.e., having a UAE server and at least one UAE client), UAS Service Suppliers (“USS”), UAS Traffic Manager (“UTM”), Unmanned Aerial Vehicle (“UAV”), UAV Controller (“UAV-C”), User Data Repository (“UDR”), User Entity/Equipment (Mobile Terminal) (“UE”), Uplink (“UL”), User Plane (“UP”), Universal Mobile Telecommunications System (“UMTS”), UMTS Terrestrial Radio Access (“UTRA”), UMTS Terrestrial Radio Access Network (“UTRAN”), User Service Description (“USD”), and Worldwide Interoperability for Microwave Access (“WiMAX”). As used herein, “HARQ-ACK” may represent collectively the Positive Acknowledge (“ACK”) and the Negative Acknowledge (“NACK”) and Discontinuous Transmission (“DTX”). ACK means that a TB is correctly received while NACK (or NAK) means a TB is erroneously received. DTX means that no TB was detected.

The subject matter disclosed herein describes apparatuses, methods, systems, and program products for providing AI-assisted QoS flow-to-QoS adaptation pattern mapping (at an AI-enabled edge application entity, which can take the form of a MEC application or a functionality at an EES/EAS). The type of analytics that assist the configuration mapping may include predictive analytics (denoting what is going to happen with respect to QoS fluctuations) or prescriptive analytics (denoting what action is needed to be taken as recommendation or enforcement, e.g., QoS upgrade/downgrade indications).

With this approach, the gNB does not need to check for QoS downgrade and upgrade continuously. This is not just offloaded to AI function, but due to the fact that this is based on mobility/traffic prediction, this allows for a one-time (less frequent) checking/QoS verification for a future potential QoS change.

### BRIEF SUMMARY

Methods for edge enabled AI/ML-assisted QoS profile configuration are disclosed. Apparatuses and systems also perform the functions of the methods.

One method for edge enabled AI/ML-assisted QoS profile configuration includes receiving at least one of actual and expected characteristics of a user equipment (“UE”) that describes a context of the UE, obtaining a data analytics model describing at least one expected network condition of a radio access network (“RAN”) node based on the characteristics of the UE, determining an expected QoS adaptation pattern, based on the obtained data analytics model, at a mobile edge computing entity within a service area of the UE, the QoS adaptation pattern comprising a sequence of QoS profiles to be used for a QoS flow for the UE over a time interval, and communicating the expected QoS adaptation pattern for the QoS flow of the UE to the UE and/or at least one network node associated with the QoS flow.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a schematic block diagram illustrating one embodiment of a wireless communication system for edge enabled AI/ML-assisted QoS profile configuration;

FIG. 1B is a diagram illustrating one embodiment of a network architecture for edge enabled AI/ML-assisted QoS profile configuration;

FIG. 2 is a diagram illustrating one example embodiment of edge enabled AI/ML-assisted QoS profile configuration;

FIG. 3A is a diagram illustrating signaling flow for one embodiment of a procedure for edge enabled AI/ML-assisted QoS profile configuration;

FIG. 3B continues the procedure of FIG. 3A;

FIG. 4 is a diagram illustrating signaling flow for one embodiment of a procedure for edge enabled AI/ML-assisted QoS profile configuration;

FIG. 5 is a diagram illustrating one embodiment of a user equipment apparatus that may be used for edge enabled AI/ML-assisted QoS profile configuration;

FIG. 6 is a diagram illustrating one embodiment of a network equipment apparatus that may be used for edge enabled AI/ML-assisted QoS profile configuration;

FIG. 7 is a flowchart diagram illustrating one embodiment of a method that may be used for edge enabled AI/ML-assisted QoS profile configuration;

FIG. 8 is a flowchart diagram illustrating one embodiment of another method that may be used for edge enabled AI/ML-assisted QoS profile configuration; and

FIG. 9 is a flowchart diagram illustrating one embodiment of yet another method that may be used for edge enabled AI/ML-assisted QoS profile configuration.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for how to configure the optimal QoS flow to QoS profile mapping for one or more ongoing sessions with minimum complexity/signaling load for RAN.

For some verticals (e.g., Smart Factories, V2X), the prediction of a QoS downgrade at the network side and the pro-active application adaptation to ensure service continuity is of key importance (esp. for URLLC type of traffic)

In some embodiment, such as for V2X, there may be requirements to support predicted QoS to the 3rd party. In this, it may be assumed that a 3GPP network provides expected QoS to the V2X Application; however, it may be that the V2X application will provide the necessary data to allow for QoS analytics. Some example of use cases include applications such as condition monitoring and predictive maintenance based on sensor data, but also big data analytics for optimizing future parameter sets of a certain process.

One further use case, which may involve the prediction of the QoS, is the eHealth vertical industry. In particular, the transfer of a patient with the ambulance to the hospital will have a predicted route, and one key requirement (if 5G eHealth services are provided, e.g., for remote surgery, video feed for remote monitoring) will be to ensure meeting the end-to-end SLA with minimum fluctuations of performance. In this scenario, by predicting the QoS possible upgrades/downgrades based on channel statistics along the route, the access network will be able to pre-allocate network and radio resources for the expected route (which may involve multiple BSs or even multiple networks).

In various embodiments, an Alternative QoS profile feature may be used. A QoS flow is the most granular measure of QoS in the 5G network and the level at which QoS is enforced, whereas a QoS profile is the set of QoS attributes (or the QoS class, aka 5QI in 5GS) which can be mapped to the QoS flow at the network side. In particular, the alternative QoS profile may include one or more of the following: a) The AF (service provider/vertical) may provide at the SLA, multiple application QoS levels for one requested session; b) 5G Network maps the session with the original and the lower priority Alternative QoS profiles (original 5QI x>Alternative 1 5QI y>Alternative 2 5QI z); c) the RAN gets informed by CN about the Alternative QoS profiles which are mapped to a QoS flow; d) the RAN checks whether the originally-set QoS attributes cannot be fulfilled—if the originally set QoS attributes cannot be fulfilled, the RAN requests CN to perform QoS downgrade to one of the Alternative QoS profiles; and/or e) when an Alternative QoS profile is used, the RAN checks continuously whether the higher priority Alternatives or the original QoS profile can be fulfilled again to perform a QoS upgrade (e.g., an upgrade to a different alternative or to the originally selected QoS profile.

The RAN may check regularly on the fulfilment/unfulfillment of a QoS profile for many QoS flows. So, the RAN may do the following for multiple flows (based on subscription or request by the upper layers): a) decide whether to perform 1) QoS Upgrade, 2) QoS Downgrade, or 3) Stay as is; b) decide to which QoS profile to Upgrade or Downgrade.

In certain embodiments, there may be additional complexity/processing at RAN nodes, which grows significantly as the number of QoS flows and the QoS alternatives increase. Furthermore, the decision on the QoS profile change is taken at the SMF; hence, considering the signaling requirement for multiple flows and frequent transitions, the real benefit may be marginal.

Furthermore, QoE is a metric related to QoS; however, QoE is focused more on the impact at the application side (it can be interpreted in more generic way of application QoS requirements). In one embodiment, the QoE may be determines as described in ITU-T P.1203.3. In various embodiments, QoE is calculated at the application layer and usually refers to video related QoE score/MOS score (video MOS or customized), initial buffering, Stalling events, Stall ratio. The QoE target may be pre-defined; however, in similar manner as QoS, different targets may be negotiated at the SLA agreement between MNO and Vertical/customer. The QoE monitoring and upgrade/downgrade decision may not be provided at RAN (currently is not supported); however, the mapping of QoE to QoS profile may be provided by upper layers (core network, application function).

In some embodiments, it may not be known how RAN will check for a possible QoS downgrade so as to adapt the QoS offering to ensure service continuity (to avoid violating minimum agreed QoS). Further, it may not be known how RAN will check for a possible QoS upgrade to provide the optimal QoS offering (ensuring maximum agreed QoS).

In various embodiments, the per user QoS and/or QoE may be pro-actively optimized in a RAN with techniques directed to one or more of the following: A) how to pro-actively/dynamically capture a QoS downgrade at RAN (QoS flow re-mapping to a lower priority QoS profile, to ensure meeting the per UE QoE targets); and/or 2) how to pro-actively/dynamically capture a QoS upgrade at RAN (QoS flow re-mapping to a higher priority QoS profile, to optimize the user and RAN performance.

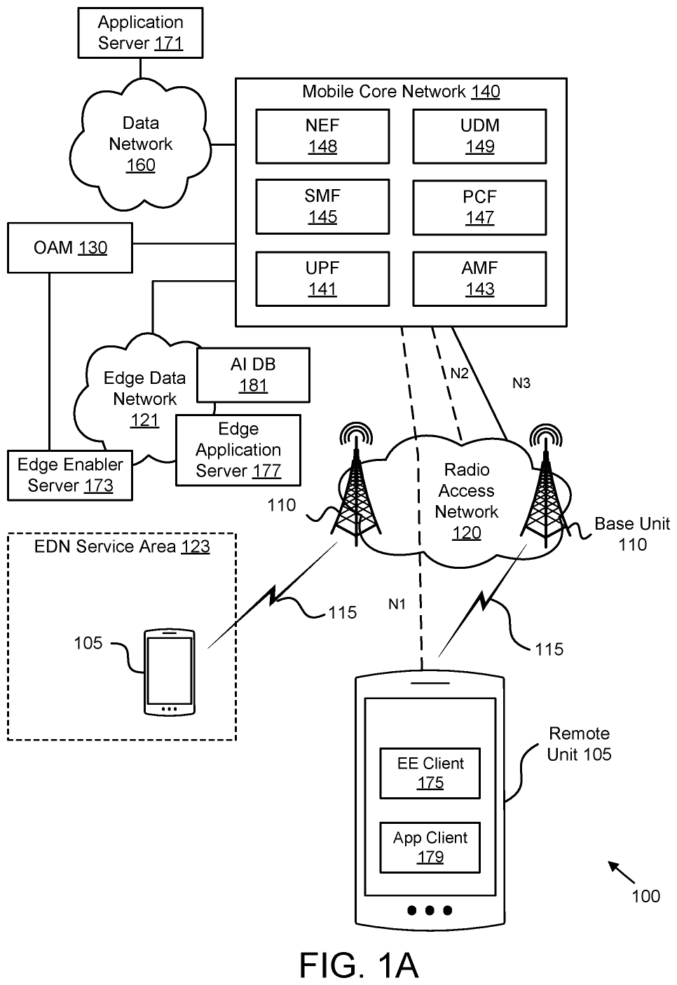

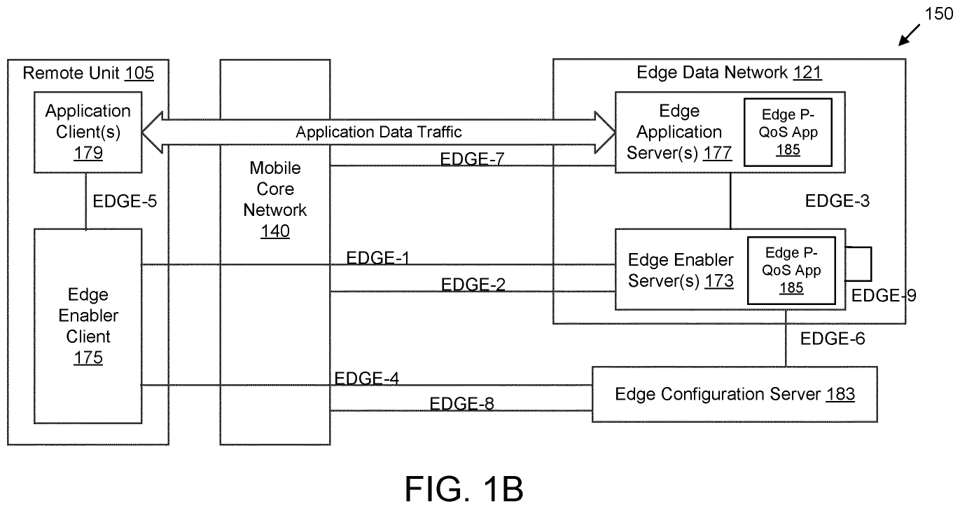

FIG. 1A depicts a wireless communication system 100 that supports an edge enabled AI/ML-assisted QoS profile configuration including at least one edge data network (“EDN”) 121 supporting an EDN service area 123. The EDN 121 includes at least one Edge Application Server (“EAS”) 177 supporting an instance of an application and an artificial intelligence/machine learning database 181. When a remote unit 105 is located in the EDN service area 123, application client 179 is able to access the EAS 177. However, when the remote unit 105 is outside any EDN service area, the application client 179 is able to access an instance of the application using the application server 171 located in the data network 160 (i.e., a regional data network). The EDN 121 also includes an edge enabler server (“EES”) 173, a middleware application enabler server, while the remote unit 105 includes an edge enabler client (“EEC”) 175.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the base units 110 in the RAN 120 via uplink (“UL”) and downlink (“DL”) communication signals. Furthermore, the UL and DL communication signals may be carried over the wireless communication links 115. Here, the RAN 120 is an intermediate network that provides the remote units 105 with access to the mobile core network 140.

In some embodiments, the remote units 105 communicate with a communication host (e.g., edge application server 173 and/or application server 171) via a network connection with the mobile core network 140. For example, an application client in a remote unit 105 may trigger the remote unit 105 to establish a PDU session (or other data connection) with the mobile core network 140 via the RAN 120. The mobile core network 140 then relays traffic between the remote unit 105 and the communication host (i.e., application server) using the PDU session. Note that the remote unit 105 may establish one or more PDU sessions (or other data connections) with the mobile core network 140. As such, the remote unit 105 may concurrently have at least one PDU session for communicating with one application server and at least one additional PDU session for communicating with another application server (not shown).

The base units 110 may be distributed over a geographic region. In certain embodiments, a base unit 110 may also be referred to as an access terminal, an access point, a base, a base station, a Node-B, an eNB, a gNB, a Home Node-B, a relay node, or by any other terminology used in the art. The base units 110 are generally part of a radio access network (“RAN”), such as the RAN 120, that may include one or more controllers communicably coupled to one or more corresponding base units 110. These and other elements of radio access network are not illustrated but are well known generally by those having ordinary skill in the art. The base units 110 connect to the mobile core network 140 via the RAN 120.

The base units 110 may serve a number of remote units 105 within a serving area, for example, a cell or a cell sector, via a wireless communication link 115. The base units 110 may communicate directly with one or more of the remote units 105 via communication signals. Generally, the base units 110 transmit DL communication signals to serve the remote units 105 in the time, frequency, and/or spatial domain. Furthermore, the DL communication signals may be carried over the wireless communication links 115. The wireless communication links 115 may be any suitable carrier in licensed or unlicensed radio spectrum. The wireless communication links 115 facilitate communication between one or more of the remote units 105 and/or one or more of the base units 110.

In one embodiment, the mobile core network 140 is a 5G core (“5GC”) or the evolved packet core (“EPC”), which may be coupled to a packet data network 150, like the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes multiple user plane functions (“UPFs”) 141. The mobile core network 140 also includes multiple control plane functions including, but not limited to, an Access and Mobility Management Function (“AMF”) 143 that serves the RAN 120, a Session Management Function (“SMF”) 145, a Policy Control Function (“PCF”) 147, a Network Exposure Function (“NEF”) 148, and a Service Capability Exposure Function (“SCEF”) 149. The NEF 148 and SCEF 149 provide means to securely expose the services and capabilities provided by 3GPP network interfaces.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network slice instance may be identified by a S-NSSAI, while a set of network slices for which the remote unit 105 is authorized to use is identified by NSSAI. In certain embodiments, the various network slices may include separate instances of network functions, such as the SMF 145 and UPF 141. In some embodiments, the different network slices may share some common network functions, such as the AMF 143. The different network slices are not shown in FIG. 1A for ease of illustration, but their support is assumed.

The wireless communication system 100 includes an OAM/Management function 130. The OAM/Management function 130 may provide slice parameters (e.g., GSTs) to the enabler servers (e.g., EES 173). In various embodiments, the OAM/Management function 130 performs slice instantiation, e.g., in response to a request from a service provider.

Although specific numbers and types of network functions are depicted in FIG. 1A, one of skill in the art will recognize that any number and type of network functions may be included in the mobile core network 140. Moreover, where the mobile core network 140 is an EPC, the depicted network functions may be replaced with appropriate EPC entities, such as an MME, S-GW, P-GW, HSS, and the like. In certain embodiments, the mobile core network 140 may include a AAA server.

While FIG. 1A depicts components of a 5G RAN and a 5G core network, the described solutions apply to other types of communication networks and RATs, including IEEE 802.11 variants, GSM, GPRS, UMTS, LTE variants, CDMA 2000, Bluetooth, ZigBee, Sigfoxx, and the like. For example, in an LTE variant involving an EPC, the AMF 143 may be mapped to an MME, the SMF mapped to a control plane portion of a PGW and/or to an MME, the UPF map to an SGW and a user plane portion of the PGW, the UDM/UDR maps to an HSS, etc.

In the following descriptions, the term eNB/gNB is used for the base station but it is replaceable by any other radio access node, e.g., BS, eNB, gNB, AP, NR, etc. Further the operations are described mainly in the context of 5G NR. However, the proposed solutions/methods are also equally applicable to other mobile communication systems supporting middleware-assisted slice and/or DNN re-mapping for vertical applications and/or edge network deployments.

FIG. 1B depicts one embodiment of a network architecture 150 for edge enabled AI/ML-assisted QoS profile configuration.

In some embodiments, for a given GBR QoS Flow, notification control is enabled, and the NG-RAN has received a list of Alternative QoS Profile(s) for this QoS Flow and supports the Alternative QoS Profile handling. In such embodiments, the following may apply:
a. If the NG-RAN determines that the GFBR, the PDB or the PER of the QoS profile cannot be fulfilled, NG-RAN shall send a notification towards SMF that the “GFBR can no longer be guaranteed”. Before sending a notification that the “GFBR can no longer be guaranteed” towards the SMF, the NG-RAN shall check whether the GFBR, the PDB and the PER that the NG-RAN currently fulfils match any of the Alternative QoS Profile(s) in the indicated priority order. If there is a match, the NG-RAN shall indicate the reference to the matching Alternative QoS Profile
b. The NG-RAN should always try to fulfil the QoS profile and any Alternative QoS Profile that has higher priority than the currently fulfilled situation. In order to avoid a too frequent signaling to the SMF, it is assumed that NG-RAN implementation can apply hysteresis (e.g., via a configurable time interval)

This problem of checking for QoS unfulfillment at RAN is not solved in current 3GPP specifications. To support adaptive QoE management schemes that enable network intelligent optimization to satisfy user experience for diverse services, a network may use AI/ML to provide support for RAN function optimization. Such adaptive QoE management schemes may also apply where base station disaggregation in central and distributed units (as well as in control and user plane) is supported.

A MEC allows the exposure of APIs from RAN to MEC platforms. The exposure of APIs from network to the edge service provider may relate to the UE location information, Bandwidth management, Radio Network Information (RNI). In some embodiments, Radio Network Information Service (RNIS) may provide radio network related information to MEC applications and to MEC platforms. The granularity of the radio network information may be adjusted based on parameters such as information per cell, per User Equipment, per QoS class or it may be requested over period of time. The Radio Network Information may be used by the MEC applications and MEC platform to optimize the existing services and to provide new type of services that are based on up to date information on radio conditions.

FIG. 1B is a diagram illustrating one example embodiment of the application layer architecture for edge service. In this architecture, as illustrated in FIG. 1B [3GPP TS 23.558], the following entities can be defined:

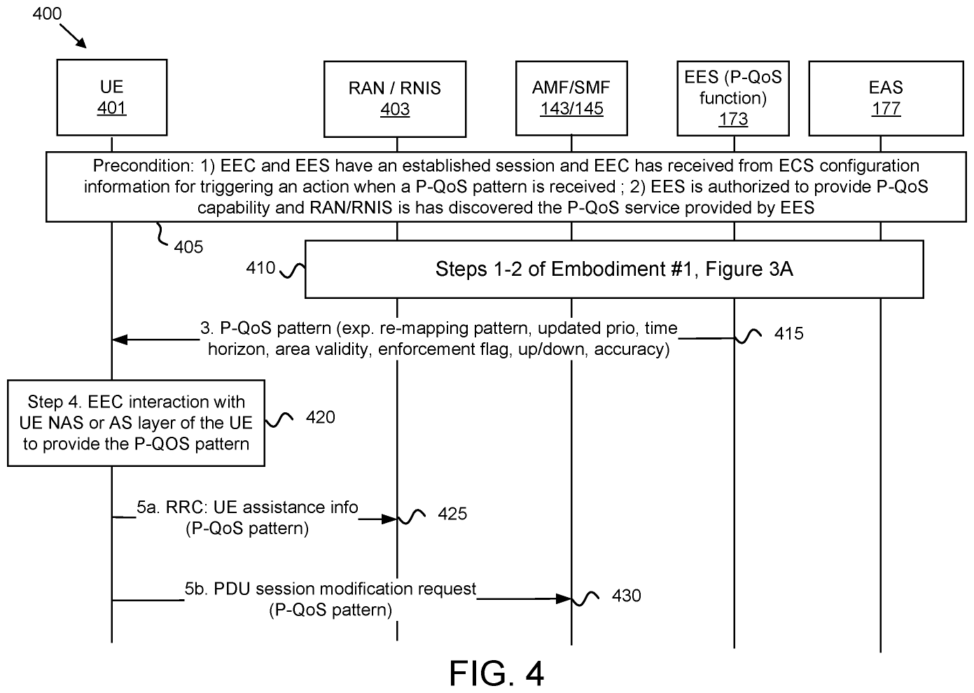

The Edge Enabler Server (“EES”) 173 provides supporting functions needed for Edge Application Servers 177 and Edge Enabler Client 175, such as one or more of: a) provisioning of configuration information to Edge Enabler Client 175, enabling exchange of application data traffic with the Edge Application Server 177; b) interacting with mobile Core Network 140 for accessing the capabilities of network functions either directly (e.g. via PCF) or indirectly (e.g. via SCEF/NEF/SCEF+NEF); and c) supports external exposure of 3GPP network capabilities to the Edge Application Server(s) 177 over EDGE-3. As depicted, the EES 173 may include an Edge P-QoS Application 185 used to configure the optimal QoS flow to QoS profile mapping for one or more ongoing sessions, as described in further detail with reference to FIG. 4.

The Edge Enabler Client (“EEC”) 175 provides supporting functions needed for Application Client(s) 179, such as retrieval and provisioning of configuration information to enable the exchange of Application Data Traffic with the Edge Application Server 177 and discovery of Edge Application Servers 177 available in the Edge Data Network 121.

The Edge Configuration Server (“ECS”) 183 provides supporting functions needed for the Edge Enabler Client 175 to connect with an Edge Enabler Server 173. These functionalities of Edge Configuration Server 183 are related to the provisioning of edge configuration information to the EEC 175, which are used for establishing connection with EES 173.

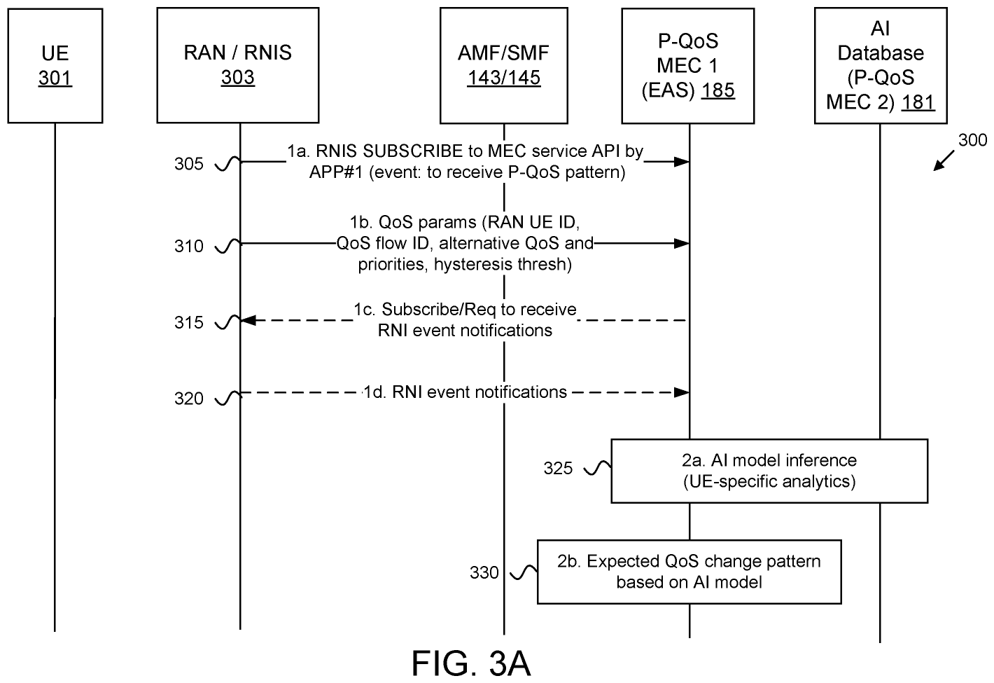

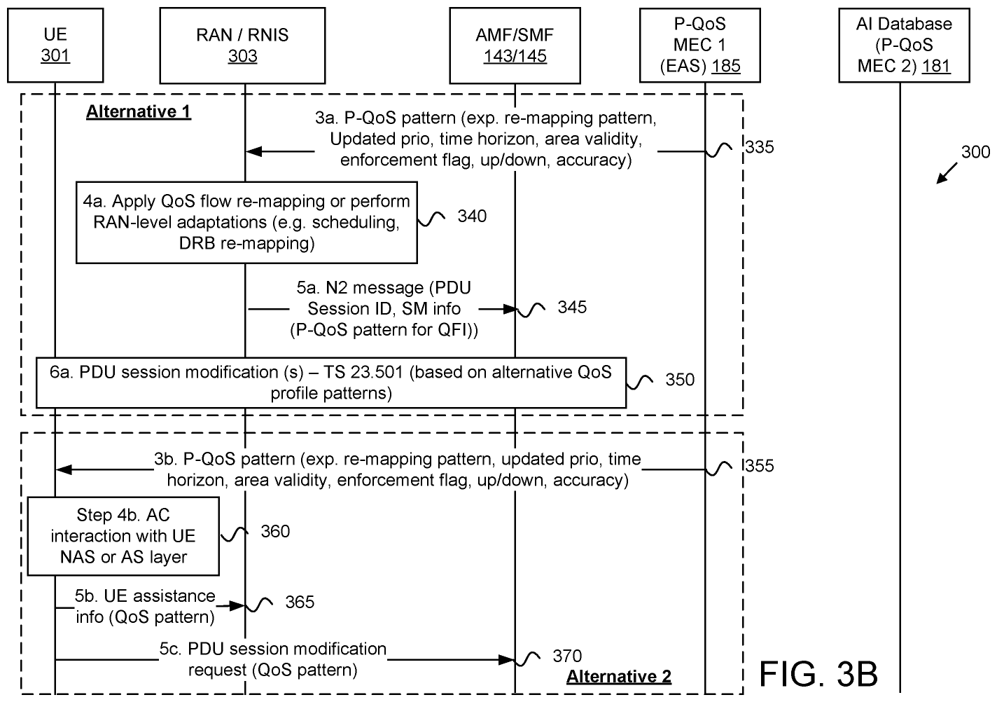

The Edge Application Server (“EAS”) 177 is the application server resident in the Edge Data Network 121, performing the server functions. As depicted, the EAS 177 may include an Edge P-QoS Application 185 used to configure the optimal QoS flow to QoS profile mapping for one or more ongoing sessions, as described in further detail with reference to FIG. 3.

The Application Client (“AC”) 179 is the application resident in the remote unit 105 performing the client function.

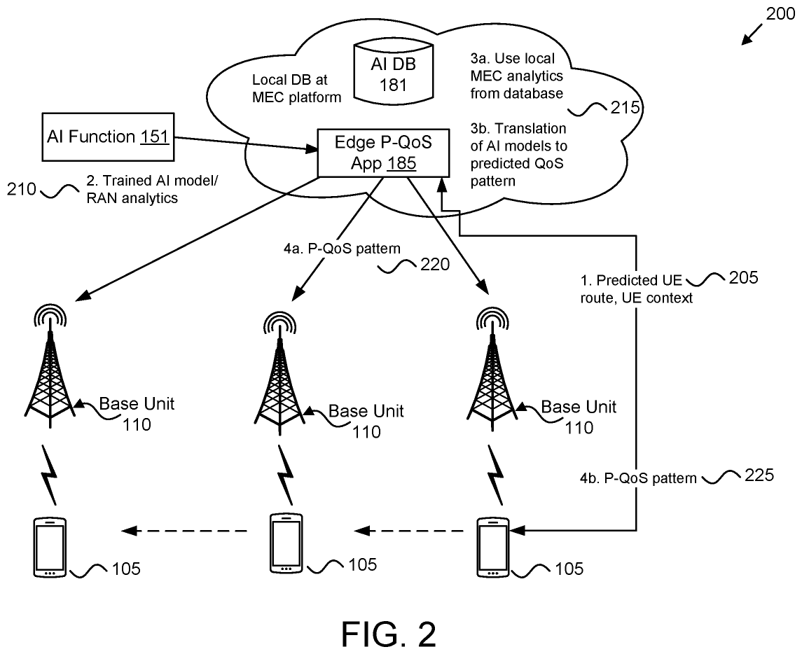

FIG. 2 is a diagram illustrating one example embodiment of edge enabled AI/ML-assisted QoS profile configuration. The procedure comprises:
a. Receiving 205 the necessary QoS flow parameters e.g., from a remote unit 105 such as a UE and/or from the RAN node 110 serving the remote unit 105 (for the flow for which the checking of QoS upgrades/downgrades is going to be offloaded to the RAN control entity e.g., an Edge P-QoS Application 185) including alternative QoS profiles with the QoS profile priorities. The QoS flow parameters may include the predicted mobility, route, trajectory, location, and/or other context or perception (e.g., sensor data such as location data, camera/video data, proximity data, and/or the like) information for the remote unit 105.
b. Upon receiving the QoS flow information, the RAN control entity (e.g., Edge P-QoS Application 185), requests and obtains 210 a trained AI/ML model, from the AI Function 151, on the expected traffic of the target cell(s) (which can be the RAN node 110 serving the remote unit and/or other RAN node(s) within the edge service area) and/or the mobility for the respective remote unit 105 (based on request or subscription). To acquire the expected mobility of the remote unit 105, it is assumed that either the RAN control entity (e.g., Edge P-QoS Application 185) is aware of the UE ID (IMEI/PEI, GPSI) and its mapping to RAN UE ID from the network, or this information is provided by the service provider (e.g., from an application function in the service provider domain) along with the mobility pattern to the RAN control entity (e.g., Edge P-QoS Application 185).
c. The AI/ML model(s) can be based on one of the following types:
   i. Supervised learning model using training data based with a known label: algorithms for this category can vary e.g. regression, k-means NN, decision tree algorithms, SVN, Bayesian algorithms etc. This allows that the ML training host and the ML model host are either co-located within the same entity (e.g. centralized AI function) or distributed in different entities (e.g. Non-RT RIC and Near-RT RIC).
   ii. Unsupervised learning model using unlabeled input data, some algorithms can be the K-means clustering and PCA. This allows that the ML training host and the ML model host are either co-located within the same entity (e.g. centralized AI function) or distributed in different entities (e.g. Non-RT RIC and Near-RT RIC).
   iii. Reinforcement learning: in this type, the agent aims to optimize a long-term objective by interacting with the environment based on a trial and error process. Popular algorithms are the Deep RM, multi-armed bandit learning, Q-learning. In one embodiment, this may involve the ML training host and the ML model host be co-located within the same entity (e.g. centralized AI function).
d. The RAN control entity (e.g., Edge P-QoS Application 185) translates 215 the obtained AI/ML model to an expected QoS adaptation pattern, which can be defined as the expected sequence of QoS profiles to be used for the QoS flow for a given time interval. The expected QoS adaptation pattern is the result of the configuration that maps the AI/ML model to expected QoS fluctuations. The following conditions are checked pro-actively:
   i. Whether a current QoS profile is expected to remain the same and for what duration/time horizon and/or geographical area.
   ii. Whether a current QoS profile is expected to downgrade, to which alternative, at what time instance, and for what duration/time horizon and/or geographical area.
   iii. Whether a current QoS profile is expected to upgrade to which alternative, at which time instance, and for what duration/time horizon and/or geographical area.
e. In one embodiment, the RAN control entity (e.g., Edge P-QoS Application 185) provides 220 the QoS adaptation pattern parameters to the serving RAN node(s) 110, based on the determined expected QoS adaptation pattern (which may include the QoS profile adaptations over a time period, time validity, geographical area, or the like for which the change applies). The serving RAN nodes 110 decide whether to apply the QoS flow remapping or whether to solve any expected QoS changes using RAN-level decisions (e.g., scheduling, QoS flow to DRB re-mapping, or the like). If a RAN node 110 decides that this involves QoS profile re-mapping, the RAN node 110 informs the AMF/SMF 143/145 on the expected QoS adaptation pattern for the QoS flow (instead of a single QoS profile change).
f. In an alternative embodiment, the RAN control entity (e.g., Edge P-QoS Application 185) provides 225 the QoS adaptation pattern parameters to the application client at the remote unit 105, e.g., a user equipment device, for which the QoS flow applies, based on the expected QoS adaptation pattern (QoS profile transitions over a time period, time validity, area for which the change applies). The application client may trigger the update of local QoS policies at the communication part of the remote unit 105, which performs one of the two actions:
   i. Send a PDU session modification request (at the NAS layer of the remote unit 105) towards the Core Network (e.g., AMF/SMF 143/145), where the expected QoS adaptation pattern is included to indicate the change of the QoS profiles pattern for the QoS flow.
   ii. Send the expected QoS adaptation pattern to the RAN node 110 over RRC (e.g. via UE assistance info), so as to allow the RAN node 110 to decide on the QoS adaptation (e.g. QoS enforcement, QoS flow to DRB re-mapping) based on the recommendation from the AI function. If this involves the QoS profile re-mapping, the RAN node 110 informs the AMF/SMF 143/145 on the expected QoS adaptation pattern for the QFI (instead of a single QoS profile change).

One particular example for the solution applicability can be the scenario when a vehicular UE is moving in a certain urban area. The AI/ML model which provides the expected mobility pattern of the UE (sequence of location coordinates in a given area between point A and point B, which can be provided by the application based on the selected route at the GPS) will be processed together with the AI/ML model which gives the expected radio channel conditions and traffic demand per cell in the same area (point A to point B), based on historical data analytics. This will derive the SINR/data rata curve which applies for this area and time when the UE is planned to move. Based on the use of the AI/ML models, the AI-enabled QoS function 151 will translate the expected radio conditions over this area, in conjunction with the QoS requirements, to a series of QoS profile changes over this time horizon.

It is noted that the foregoing description mentions predictive QoS patterns; however, it is not limited to QoS profile but can be extended to QoE. In that case, the RAN undertakes the task to translate the QoE pattern (e.g., expected service experience over a time horizon) to QoS profile pattern.

FIGS. 3A-3B is a diagram illustrating signaling flow for one embodiment of a procedure 300 for edge enabled AI/ML-assisted QoS profile configuration.

### Embodiment 1—Implementation for MEC/EDGE Deployments (AI Function as Part of Edge Application Server/MEC Application)

In this embodiment, the ETSI MEC architecture is considered for the implementation of the solution. A RAN node 303 (or more specifically RNIS) initially subscribes to the MEC platform to consume the service provided by the P-QoS MEC application 185, which may be an application function that is part of or provided by an EAS 177 and that configures the expected QoS adaptation pattern. The P-QoS MEC application 185 has as main functionality to provide the expected QoS adaptation pattern for the respective QoS flow(s) of the target UE 301. This is based on the RNIS inputs and the training/inference of the AI/ML model related to the UE/RAN expected behavior, e.g., UE mobility pattern, RAN traffic demand expectation, and/or the like. This can be seen as a new API which is consumed by the RAN/RNIS and produced by a MEC application to optimize QoS/QoE offering for the target UE(s) 301.

Step 1a: The RAN/RNIS node 303 subscribes to the AI function (see messaging 305), which is deployed as a P-QoS MEC application 185, to be notified on the expected QoS adaptation pattern, which can be in form of predictive or prescriptive QoS analytics. This subscription assumes that the AI function is consumed by the RNIS in the RAN node 303 as a MEC Service API and produced by the MEC platform. In the request/subscription message, the RNIS/RAN node 303 can also request the type of AI/ML model to be used, type of QoS analytics to be used (predictive or prescriptive) and/or the expected accuracy/training configuration (and let the MEC app function to apply the most preferable algorithm). Possible implementations include:
a. The service consumer (RNIS) sends a POST request with the message body containing the {NotificationSubscription} data structure to the resource representing P-QoS service subscription. The variable {NotificationSubscription} defines the subscribed event, the filtering criteria, and the address where the service consumer wishes to receive the P-QoS event notifications.
b. P-QoS MEC Application 185 sends a “Created” response with the message body containing the data structure specific to that RNI subscription. The data structure contains the address of the resource created and the subscribed RNI event type.

Step 1b: The RNIS/RAN node 303, after the subscription/request message 305 for receiving the expected QoS adaptation pattern, provides (see messaging 310), optionally after a request by the P-QoS MEC application 185, the QoS parameters which are needed at the AI function 151 to provide prescriptive/predictive analytics. The parameters may include:
a. QoS flow ID (s)/session ID
b. List of QoS profiles (original and alternatives)
c. Priorities of QoS profiles
d. Geographical area
e. Time validity
f. Hysteresis threshold
g. S-NSSAI

Step 1c/1d: The RNIS/RAN node 303 may also provide radio parameters to support the P-QOS MEC application 185 on its decision. This information may be sent as a report periodically or in an event-based manner (the radio parameters requirements and the periodicity is based on configuration at step (1a) in order to allow the AI function 151 to collect enough data for enhancing the AI/ML model with up-to-date channel information. This may involve the subscription/request (see messaging 315) of the service consumer (P-QoS MEC application 185) to receive from the RNIS/RAN node 303 events on radio parameters. In this embodiment, the event notification (see messaging 320) may include events related to the following parameters:
a. CSI (CQI, PMI, RI) measurements
b. RRM/RLM measurements
c. RRC user/cell parameters
d. RRM function outputs (e.g. ICIC/eICIC info)
e. Slice related parameters (e.g. slice capacity, slice RRM policies)
f. UE context parameters (UE location, mobility/velocity)

Step 2a: The P-QoS MEC application 185 interacts (see block 325) with the AI model designer (which can be an external entity) or the corresponding AI database 181 (assuming that a database is storing the UE and RAN related analytics), which can be other MEC applications of the same or different cloud/MEC platform, to fetch the data needed to perform AI model inference. In this step, the model is trained and the model can be related to the UE expected behavior (e.g., expected location, traffic demand, sequence of handovers, or the like) and/or the expected status of the RAN node 303 (e.g., expected performance downgrade, expected UL/DL traffic demand, expected backhaul conditions, expected DRB load, or the like) for a given time frame and geographical area.

Step 2b: The P-QoS MEC application 185 translates the trained AI model to an expected QoS adaptation pattern for the respective QoS flow (see block 330), considering the list of QoS profiles and their priorities, the expected UE 301 and/or RAN node 303 behavior, the hysteresis threshold (which may impact the number of allowed transitions), the expected accuracy of the prediction, which may be configured per area within the cell, and/or the like.

Based on this translation, the P-QoS MEC application 185 determines the QoS flow to expected QoS adaptation pattern mapping. This may also include a tuning of the hysteresis threshold for a given time or area (e.g., in a tunnel) to capture some deep QoS downgrades within a pre-defined hysteresis.

At this point, two alternatives are possible, one via an API to UE 301, and one via interaction with the UE 301, as shown in FIG. 3B.

Alternative 1:

Step 3a: The P-QoS MEC application 185 sends (see messaging 335) a report with the expected QoS adaptation pattern for the QoS flow to the RNIS/RAN node 303 (if Step 1a is based on subscription, this is a NOTIFY message). This includes one or more of the following:
a. QoS flow ID
b. An expected QoS adaptation pattern in the form of a list (<QoS flow, QoS profile x, y, . . . , t1, t2, . . . >) or table per flow (QoS profile×Time instances)
c. tuning of hysteresis threshold and cause
d. accuracy of prediction per area (within the cell or per cell) and time
e. area of validity and time horizon for the prediction
f. enforcement flag (whether the QoS profile pattern needs to be enforced or it allows RAN to take further actions, e.g. DRB remapping)
g. upgrade or downgrade indication per QoS transition
h. type of analytics used (predictive, prescriptive)

Step 4a: The RNIS/RAN node 303, upon receiving the report, evaluates (see block 340) whether the expected QoS adaptation pattern involves the adaptation of QoS profile pattern (based on the enforcement flag, accuracy, or the like) and the possible change of hysteresis threshold, or some action can be performed at the RAN node level to avoid adapting the QoS profile (e.g., scheduling, adaptation of DRB resources/mapping, or the like).

Step 5a: The RAN node 303 sends (see messaging 345) to the SMF 145 via the AMF 143 an N2 message to indicate the expected QoS adaptation pattern for the QFI. The N2 message is specified in TS 23.502; however, this may not include a predictive QoS profile pattern, but an individual QoS profile that needs to change for the QoS flow.

In some embodiments, the N2 SM information includes the QFI and an indication that the QoS targets for that QoS Flow cannot be fulfilled or can be fulfilled again, respectively. When QoS targets cannot be fulfilled, the QoS profile that matches the values of the QoS parameters from the expected QoS adaptation pattern is sent as part of the N2 SM information. In step 5a, the N2 SM information also includes the QoS profile pattern, which can be in the form of a list (<QFI, QoS profile x, y, . . . , t1, t2, . . . >) or table per QFI (QoS profile×Time instances).

Step 6a: PDU session modifications are triggered (e.g., based on TS 23.501/502) (see block 350), whereas the main difference from the current specification is that this is based on the alternative QoS profile patterns (and may involve further modification in predefined time periods).

Alternative 2:

Step 3b: The P-QoS MEC application 185, e.g., EAS, sends (see messaging 355) a report with the expected QoS adaptation pattern for the QoS flow to the application client 179 at the respective UE 301. This includes one or more of the following:
a. application ID, EAS ID, EAS ID, UE ID (GPSI)
b. QoS flow ID, session ID
c. An expected QoS adaptation pattern in the form of a list (<QoS flow, QoS profile x, y, . . . , t1, t2, . . . >) or table per flow (QoS profile×Time instances)
d. tuning of hysteresis threshold and cause
e. accuracy of prediction per area (within the cell or per cell) and time
f. area of validity and time horizon for the prediction
g. enforcement flag (whether the QoS profile pattern needs to be enforced or it allows RAN to take further actions, e.g. DRB remapping)
h. upgrade or downgrade indication per QoS transition
i. type of analytics used (predictive, prescriptive)

Step 4b: The application client 179 interacts (see block 360) with the communication part of the UE 301 to provide the expected QoS adaptation pattern. This can be at the NAS layer (if a QoS profile is decided to change) or at the AS layer (if the QoS change can be performed at DRB level (change resource request for a given future time window)).

Step 5b: If the change impacts the PDU session to QoS profile mapping, the UE 301 sends (see messaging 365) a PDU session modification request to AMF/SMF 143/145 via N1 signaling. In certain embodiments, the PDU session modification follows procedures defined in 3GPP TS 23.502 clause 4.3.3. As a new parameter in this message apart from the Requested QoS, the expected QoS adaptation pattern to be mapped to the QoS flow is sent to the AMF 143.

Step 5c: If the change impacts the radio resource configuration and allocation, the UE 301 sends (see messaging 370) a request to the RRC function of the BS (e.g. via UE assistance information) to provide the expected QoS adaptation pattern (flow to DRB re-mappings at given time instances). This will trigger the predictive adaptation of the DRB mappings.

FIG. 4 is a diagram illustrating signaling flow for one embodiment of a procedure 400 for edge enabled AI/ML-assisted QoS profile configuration.

### Embodiment 2—Implementation for MEC/EDGE Deployments (AI Function as Part of Edge Enabler Server)

In this embodiment, the ETSI MEC/3GPP SA6 EDGEAPP architecture is considered for the implementation of the solution. The P-QoS function at EES 173 has as main functionality to provide the expected QoS adaptation pattern for the respective QoS flow(s) of the target UE 301. This is based on the RNIS/RAN node 403 inputs and the training/inference of the AI/ML model related to the UE 301/RAN node 403 expected behavior (e.g., UE mobility pattern, RAN traffic demand expectation, or the like). This can be seen as a new API which is consumed by the RNIS/RAN node 403 and produced by EES 173 to optimize QoS/QoE offering for the target UE(s) 301. The EES 173 determines the P-QoS pattern and provides the pattern to the EEC 175 of the UE 401 to allow for predictive QoS adaptation at either the RAN node level (e.g., via DRB re-mapping) or at the CN level (e.g., via PDU session modification).

Pre-conditions (Step 0, block 405): First, the EEC 175 at the UE 301 and the EES 173 have an established session and the EEC 175 has received from the ECS 183 configuration information for triggering an action when a P-QoS pattern is received, and second, the EES 173 is authorized to provide P-QoS capability and RNIS/RAN node 403 has discovered the P-QoS service provided by the EES 173.

Steps 1-2 (see block 410) are the same as the corresponding steps in Embodiment #1, shown in FIG. 3A.

Step 3: The EES 173 sends (see messaging 415) a report with the expected QoS adaptation pattern for the QoS flow to the EEC 175 at the respective UE 401. This may include one or more of the following:
a. application ID, EES ID, EAS ID, UE ID (GPSI)
b. QoS flow ID, session ID
c. an expected QoS adaptation pattern in the form of a list (<QoS flow, QoS profile x, y, . . . , t1, t2, . . . >) or table per flow (QoS profile×Time instances)
d. tuning of hysteresis threshold and cause
e. accuracy of prediction per area (within the cell or per cell) and time
f. area of validity and time horizon for the prediction
g. enforcement flag (whether the QoS profile pattern needs to be enforced or it allows RAN to take further actions, e.g. DRB remapping)
h. upgrade or downgrade indication per QoS transition
i. type of analytics (prescriptive or predictive)

Step 4: The EEC 175 at the UE 401 interacts (see block 420) with the communication part of the UE 401 (e.g., a mobile terminal or other termination point for the network connections of the UE 401) to provide the expected QoS adaptation pattern (e.g., P-QoS pattern). This can be at the NAS layer (if a QoS profile is decided to change) or at the AS layer (if the QoS change can be performed at DRB level (change resource request for a given future time window)).

Step 5a (Option 1): If the change impacts the radio resource configuration and allocation, the UE 401 sends (see messaging 425) a request to the RRC function of the BS (e.g. via UE assistance information) to provide the expected QoS adaptation pattern (flow to DRB re-mappings at given time instances. This will trigger that predictive adaptation of the DRB mappings.

Step 5b (Option 2): If the change impacts the PDU session to QoS profile mapping, the UE 401 sends (see messaging 430) a PDU session modification request to the AMF/SMF 143/145 via N1 signaling (e.g., using current procedures as defined in TS23.502 clause 4.3.3). As a new parameter in this message apart from the Requested QoS, the expected QoS adaptation pattern to be mapped to the QoS flow is sent to AMF 143.

As it relates to Embodiments 1 and 2 in FIGS. 3A/3B and 4, as mentioned above, the P-QoS capability in this embodiment may involve the exposure of the RNI API to the P-QoS MEC application 185 (AI function) as well as the UE QoS API (this can be part of RNI API or different), which is exposed to the MEC platform to provide the QoS flow parameters to the P-QoS function. The UE QoS API can be exposed from the 5GC via NEF or via RAN (assuming cloud-RAN deployments). Furthermore, the UE P-QoS pattern API can be consumed by a network entity (e.g., RAN). Below we provide the APIs which may be needed.

UE QoS API (Step 1b):
a. API operation name: UE_QOS
b. Description: Provides QoS flow parameters including the alternative QoS profiles and the priorities.
c. Known Producer: RNIS, RAN node
d. Known Consumers: AI function, MEC platform, MEC app, EES
e. Inputs: P-QoS app request, successful RNIS subscription to P-QoS
f. Outputs: response/ACK to RNIS

UE P-QoS Pattern API (Step 3a/3b)
a. API operation name: UE_PQOS_pattern
b. Description: Determines the expected QoS adaptation pattern for the QoS flow
c. Known Producer: AI function, MEC platform, MEC app, EES
d. Known Consumers: RNIS, RAN function, EEC @UE
e. Inputs: RNIS subscription to P-QoS app
f. Outputs: P-QoS pattern (aka expected QoS adaptation pattern) configuration message to RNIS/RAN function

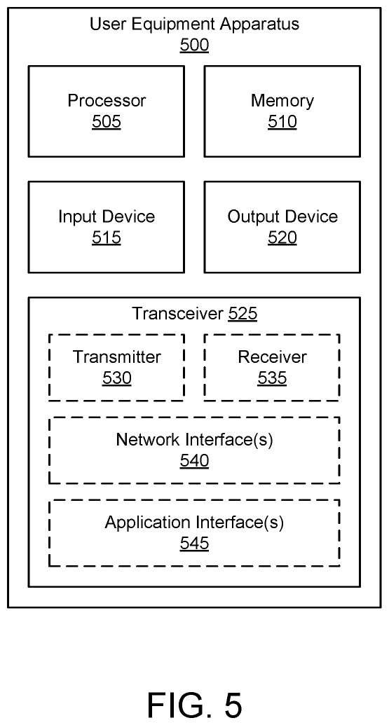

FIG. 5 is a diagram illustrating one embodiment of a user equipment apparatus that may be used for edge enabled AI/ML-assisted QoS profile configuration, according to embodiments of the disclosure. In various embodiments, the user apparatus 500 is used to implement one or more of the solutions described above. The user apparatus 500 may include a processor 505, a memory 510, an input device 515, an output device 520, and a transceiver 525. In some embodiments, the input device 515 and the output device 520 are combined into a single device, such as a touchscreen. In certain embodiments, the user apparatus 500 may not include any input device 515 and/or output device 520. In various embodiments, the user apparatus 500 may include one or more of: the processor 505, the memory 510, and the transceiver 525, and may not include the input device 515 and/or the output device 520.

The processor 505, in one embodiment, may include any known controller capable of executing computer-readable instructions and/or capable of performing logical operations. For example, the processor 505 may be a microcontroller, a microprocessor, a central processing unit (“CPU”), a graphics processing unit (“GPU”), an auxiliary processing unit, a FPGA, or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525.

In various embodiments, the processor 505 controls the user apparatus 500 to implement the above described UE and/or UE client behaviors.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to end-to-end QoS fulfillment. For example, the memory 510 may store policies, parameters, and the like. In certain embodiments, the memory 510 also stores program code and related data, such as an operating system or other controller algorithms operating on the UE.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the user apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all or portions of the output device 520 may be integrated with the input device 515. For example, the input device 515 and output device 520 may form a touchscreen or similar touch-sensitive display. In other embodiments, the output device 520 may be located near the input device 515.

As discussed above, the transceiver 525 communicates with one or more network equipment devices, described below. The transceiver 525 operates under the control of the processor 505 to transmit messages, data, and other signals and also to receive messages, data, and other signals. For example, the processor 505 may selectively activate the transceiver (or portions thereof) at particular times in order to send and receive messages.

In various embodiments, the transceiver 525 is configured to communication with 3GPP access network(s) and/or the non-3GPP access network(s). In some embodiments, the transceiver 525 implements modem functionality for the 3GPP access network(s) and/or the non-3GPP access network(s). In one embodiment, the transceiver 525 implements multiple logical transceivers using different communication protocols or protocol stacks, while using common physical hardware.

In one embodiment, the transceiver 525 includes a first transmitter/receiver pair used to communicate with a mobile communication network over licensed radio spectrum and a second transmitter/receiver pair used to communicate with a mobile communication network over unlicensed radio spectrum. In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 525, transmitters 530, and receivers 535 may be implemented as physically separate components that access a shared hardware resource and/or software resource, such as for example, the network interface 540.

The transceiver 525 may include one or more transmitters 530 and one or more receivers 535. Although a specific number of transmitters 530 and receivers 535 are illustrated, the user equipment apparatus 500 may have any suitable number of transmitters 530 and receivers 535. Further, the transmitter(s) 530 and the receiver(s) 535 may be any suitable type of transmitters and receivers. In certain embodiments, the one or more transmitters 530 and/or the one or more receivers 535 may share transceiver hardware and/or circuitry. For example, the one or more transmitters 530 and/or the one or more receivers 535 may share antenna(s), antenna tuner(s), amplifier(s), filter(s), oscillator(s), mixer(s), modulator/demodulator(s), power supply, and the like.

In various embodiments, the transceiver 525 is capable of communicating with a mobile core network via an access network. Accordingly, the transceiver 525 may support at least one network interface 540. Here, the at least one network interface 540 facilitates communication with a RAN node, such as an eNB or gNB, for example using the “Uu” interface (e.g., LTE-Uu for eNB, NR-Uu for gNB). Additionally, the at least one network interface 540 may include an interface used for communications with one or more network functions in the mobile core network, such as a UPF 141, an AMF 143, a SMF 145, and/or a PCF 147. In certain embodiments, the transceiver 525 may support a PC5 interface for sidelink communication. The transceiver 525 and/or processor 505 may support one or more application interfaces 545.

In various embodiments, one or more transmitters 530 and/or one or more receivers 535 may be implemented and/or integrated into a single hardware component, such as a multi-transceiver chip, a system-on-a-chip, an application-specific integrated circuit (“ASIC”), or other type of hardware component. In certain embodiments, one or more transmitters 530 and/or one or more receivers 535 may be implemented and/or integrated into a multi-chip module. In some embodiments, other components such as the network interface 540 or other hardware components/circuits may be integrated with any number of transmitters 530 and/or receivers 535 into a single chip. In such embodiment, the transmitters 530 and receivers 535 may be logically configured as a transceiver 525 that uses one more common control signals or as modular transmitters 530 and receivers 535 implemented in the same hardware chip or in a multi-chip module. In certain embodiments, the transceiver 525 may implement a 3GPP modem (e.g., for communicating via NR or LTE access networks) and a non-3GPP modem (e.g., for communicating via Wi-Fi or other non-3GPP access networks).

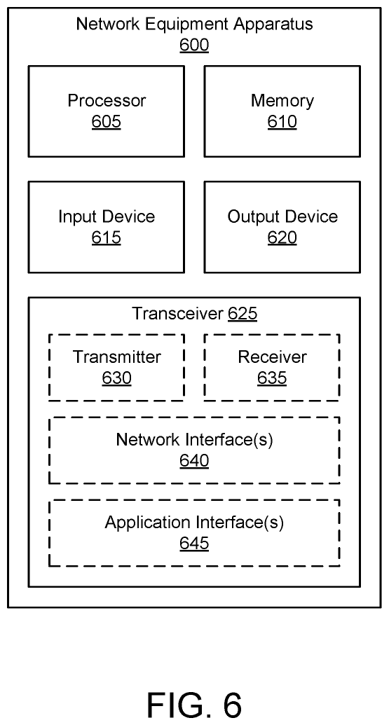

FIG. 6 is a diagram illustrating one embodiment of a network equipment apparatus that may be used for edge enabled AI/ML-assisted QoS profile configuration, according to embodiments of the disclosure. Network equipment apparatus 600 may include a processor 605, a memory 610, an input device 615, an output device 620, a transceiver 625, and application interface 645. In some embodiments, the input device 615 and the output device 620 are combined into a single device, such as a touch screen. In certain embodiments, the network equipment apparatus 600 does not include any input device 615 and/or output device 620.

As depicted, the transceiver 625 includes at least one transmitter 630 and at least one receiver 635. Here, the transceiver 625 communicates with one or more remote units 105. Additionally, the transceiver 625 may support at least one network interface 640 and/or application interface 645. In some embodiments, the transceiver 625 supports an interface (e.g., a Nnef interface) for communicating with a NEF (i.e., the NEF 148). Other network interfaces may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the first transceiver 625.

In various embodiments, the processor 605 controls the network equipment apparatus 600 to implement the above described edge enabled AI/ML-assisted QoS profile configuration behaviors. For example, via the interfaces 640/645, the processor 605 may receive a request for edge enabled AI/ML-assisted QoS profile configuration. In some embodiments, the one or more characteristics of the UE comprises a UE mobility pattern, the UE mobility pattern comprising at least one of the following parameters: a sequence of location coordinates for the UE for different time instances within a given area, a sequence of cell handovers for different time instances within a given area, an estimated trajectory of the UE, an HD location map, and an expected speed/velocity of the UEI.

In some embodiments, the processor 605 receives from at least one serving RAN node (e.g., via the interface(s) 640/645) at least one of the following QoS configuration parameters: a QoS flow ID, a list of QoS profiles, priorities of QoS profiles, a geographical area, a time validity, a hysteresis threshold, and/or an S-NSSAI; and at least one of the following radio parameters: averaged CSI; abstracted CSI measurements; RRM measurements; RLM measurements; RRC parameters for a user; RRC parameters for a cell; RRM function outputs; parameters for a network slice (e.g., slice capacity, slice RRM policies); and UE context parameters (e.g., UE location, UE mobility/velocity).

The processor 605 determines an expected QoS adaptation pattern, based on an obtained data analytics model, at a mobile edge computing entity within a service area of the UE. The data analytics model comprises an artificial intelligence model that is trained for expected RAN resource conditions and/or expected wireless backhaul resource conditions. In certain embodiments, the data analytics model is a trained AI model including at least one of: expected RAN resource conditions (e.g., channel statistics distribution over the entire area with highs and lows) for a future duration (e.g., the next 10 ms to 1 sec—based on the configuration and accuracy of prediction); expected wireless backhaul resource conditions (i.e., channel statistics distribution for the involved backhaul links) for the future duration (i.e., the next 10 ms to 1 sec—based on the configuration and the accuracy of prediction); an expected UE mobility pattern and/or expected UE trajectories for each UE in a service area (e.g., based on the accuracy of prediction); an expected channel quality fluctuation in an expected route of the at least one UE; and expected performance metrics for one or more selected UEs in the service area.

The QoS adaptation pattern comprises a sequence of QoS profiles to be associated with a QoS flow for the UE over a time interval. The processor 605 communicates, e.g., via the transmitter 630, the expected QoS adaptation pattern for the QoS flow of the UE to the UE and/or at least one network node associated with the QoS flow.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media. In some embodiments, the memory 610 stores data relating to selecting a server application instance, for example storing server addresses, UE locations, DNS cache, and the like. In certain embodiments, the memory 610 also stores program code and related data, such as an operating system (“OS”) or other controller algorithms operating on the network equipment apparatus 600 and one or more software applications.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, may include any known electronically controllable display or display device. The output device 620 may be designed to output visual, audible, and/or haptic signals. In some embodiments, the output device 620 includes an electronic display capable of outputting visual data to a user. For example, the output device 620 may include, but is not limited to, an LCD display, an LED display, an OLED display, a projector, or similar display device capable of outputting images, text, or the like to a user. As another, non-limiting, example, the output device 620 may include a wearable display such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, all or portions of the output device 620 may be located near the input device 615.

As discussed above, the transceiver 625 may communicate with one or more remote units and/or with one or more interworking functions that provide access to one or more PLMNs. The transceiver 625 may also communicate with one or more network functions (e.g., in the mobile core network 120). The transceiver 625 operates under the control of the processor 605 to transmit messages, data, and other signals and also to receive messages, data, and other signals. For example, the processor 605 may selectively activate the transceiver (or portions thereof) at particular times in order to send and receive messages.

The transceiver 625 may include one or more transmitters 630 and one or more receivers 635. In certain embodiments, the one or more transmitters 630 and/or the one or more receivers 635 may share transceiver hardware and/or circuitry. For example, the one or more transmitters 630 and/or the one or more receivers 635 may share antenna(s), antenna tuner(s), amplifier(s), filter(s), oscillator(s), mixer(s), modulator/demodulator(s), power supply, and the like. In one embodiment, the transceiver 625 implements multiple logical transceivers using different communication protocols or protocol stacks, while using common physical hardware.

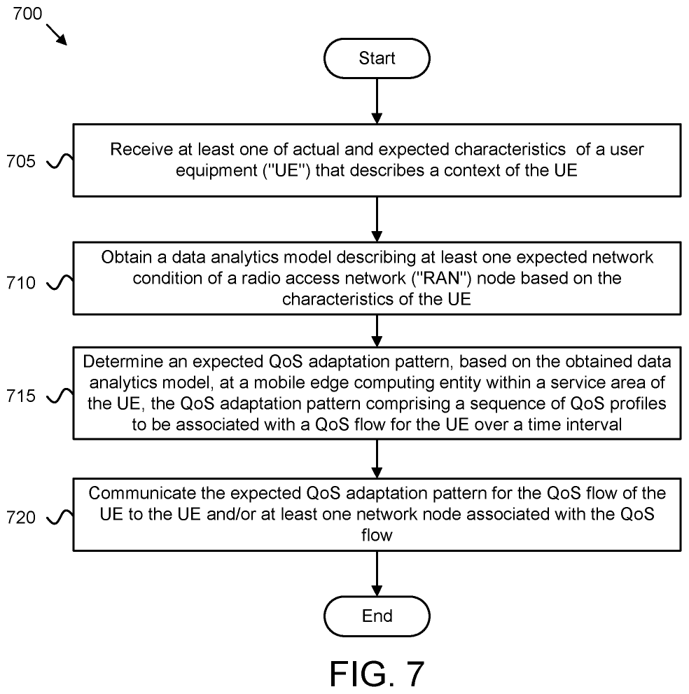

FIG. 7 depicts one embodiment of a method 700 for edge enabled AI/ML-assisted QoS profile configuration, according to embodiments of the disclosure. In various embodiments, the method 700 is performed by a network equipment apparatus 600, described above. In some embodiments, the method 700 is performed by a processor, such as a microcontroller, a microprocessor, a CPU, a GPU, an auxiliary processing unit, a FPGA, or the like.

The method 700 begins and receives 705 at least one of actual and expected characteristics of a user equipment (“UE”) that describes a context of the UE. The method 700 obtains 710 a data analytics model describing at least one expected network condition of a radio access network (“RAN”) node based on the characteristics of the UE.

The method 700 determines 715 an expected QoS adaptation pattern, based on the obtained data analytics model, at a mobile edge computing entity within a service area of the UE. The QoS adaptation pattern may include a sequence of QoS profiles to be associated with a QoS flow for the UE over a time interval. The method 700 communicates 720 the expected QoS adaptation pattern for the QoS flow of the UE to the UE and/or at least one network node associated with the QoS flow, and the method 700 ends.

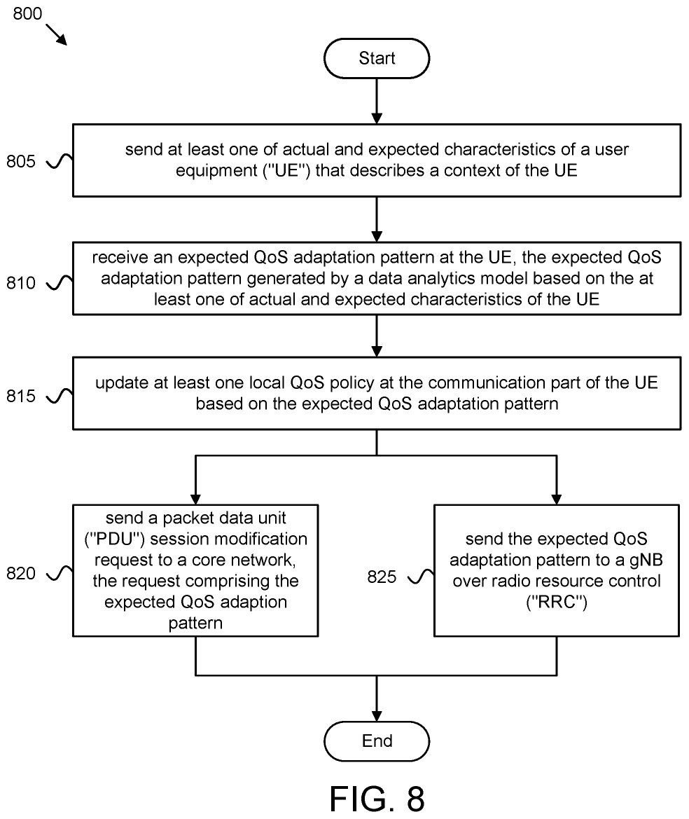

FIG. 8 depicts one embodiment of a method 800 for edge enabled AI/ML-assisted QoS profile configuration, according to embodiments of the disclosure. In various embodiments, the method 800 is performed by a user equipment apparatus 500, described above. In some embodiments, the method 800 is performed by a processor, such as a microcontroller, a microprocessor, a CPU, a GPU, an auxiliary processing unit, a FPGA, or the like.

The method 800 begins and sends 805 at least one of actual and expected characteristics of a user equipment (“UE”) that describes a context of the UE. The method 800 receives 810 an expected QoS adaptation pattern at the UE. The expected QoS adaptation pattern may be generated by a data analytics model based on the at least one of actual and expected characteristics of the UE. The expected QoS adaptation pattern may include a sequence of QoS profiles to be associated with a QoS flow for the UE over a time interval.

The method 800 updates 815 at least one local QoS policy at the communication part of the UE based on the expected QoS adaptation pattern. The method 800 sends 820 a packet data unit (“PDU”) session modification request to a core network. The request may include the expected QoS adaption pattern. The method 800 sends 825 the expected QoS adaptation pattern to a gNB over radio resource control (“RRC”), and the method 800 ends.

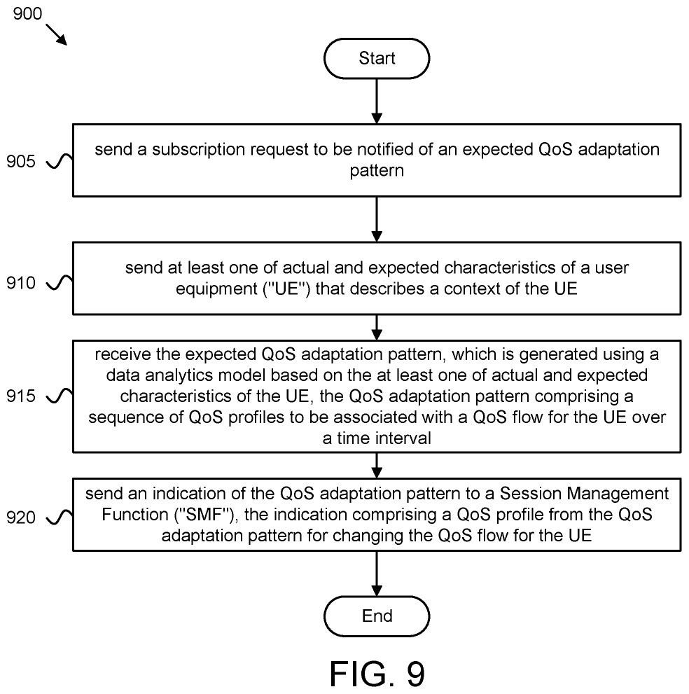

FIG. 9 depicts one embodiment of a method 900 for edge enabled AI/ML-assisted QoS profile configuration, according to embodiments of the disclosure. In various embodiments, the method 900 is performed by a network equipment apparatus 600, described above. In some embodiments, the method 900 is performed by a processor, such as a microcontroller, a microprocessor, a CPU, a GPU, an auxiliary processing unit, a FPGA, or the like.

The method 900 begins and sends 905 a subscription request to be notified of an expected QoS adaptation pattern. The method 900 sends 910 at least one of actual and expected characteristics of a user equipment (“UE”) that describes a context of the UE. The method 900 receives 915 the expected QoS adaptation pattern, which is generated using a data analytics model based on the at least one of actual and expected characteristics of the UE. The expected QoS adaptation pattern includes a sequence of QoS profiles to be associated with a QoS flow for the UE over a time interval.

The method 900 sends 920 an indication of the QoS adaptation pattern to a Session Management Function (“SMF”). The indication includes a QoS profile from the QoS adaptation pattern for changing the QoS flow for the UE, and the method 900 ends.

Disclosed herein is a first method for edge enabled AI/ML-assisted QoS profile configuration. The first method may be performed by a network equipment apparatus 600. The first method includes receiving at least one of actual and expected characteristics of a user equipment (“UE”) that describes a context of the UE. The method includes obtaining a data analytics model describing at least one expected network condition of a radio access network (“RAN”) node based on the characteristics of the UE. The method includes determining an expected QoS adaptation pattern, based on the obtained data analytics model, at a mobile edge computing entity within a service area of the UE, the QoS adaptation pattern comprising a sequence of QoS profiles to be associated with a QoS flow for the UE over a time interval. The method includes communicating the expected QoS adaptation pattern for the QoS flow of the UE to the UE and/or at least one network node associated with the QoS flow.

In certain embodiments, the method includes receiving a subscription request from the entity to be notified of the expected QoS adaptation pattern. In one embodiment, the subscription request comprises a type of data analytics model to be used, types of QoS analytics to be used, and/or an expected accuracy and/or training configuration for the data analytics model.

In certain embodiments, the method includes receiving one or more QoS configuration parameters from a serving RAN node within the service area of an edge data network. In some embodiments, the QoS configuration parameters comprise a QoS flow ID, a list of QoS profiles, priorities of QoS profiles, a geographical area, a time validity, a hysteresis threshold, and/or an S-NSSAI.

In various embodiments, the method includes receiving one or more radio parameters from a serving RAN node within the service area of an edge data network and enhancing the data analytics model with up-to-date channel information. In some embodiments, the one or more radio parameters comprise CSI measurements, radio resource management (“RRM”) measurements, radio link monitoring (“RLM”) measurements, radio resource control (“RRC”) parameters for a user, RRC parameters for a cell, RRM function outputs, parameters for a network slice, and/or UE context parameters.

In one embodiment, the data analytics model comprises an artificial intelligence model that is trained for expected RAN resource conditions and/or expected wireless backhaul resource conditions. In various embodiments, the one or more characteristics of the UE comprises a UE mobility pattern, the UE mobility pattern comprising at least one of the following parameters: a sequence of location coordinates for the UE for different time instances within a given area, a sequence of cell handovers for different time instances within a given area, an estimated trajectory of the UE, an HD location map, and an expected speed/velocity of the UE.

In one embodiment, the expected QoS adaptation pattern indicates one of a current QoS profile is expected to remain the same for a particular time duration within the time interval and/or geographical area; a current QoS profile is expected to downgrade to a different QoS profile a particular time instance, within the time interval, for a particular time duration and/or geographical area; and a current QoS profile is expected to upgrade to a different QoS profile at a particular time instance, within the time interval, for a particular time duration and/or geographical area.

In certain embodiments, the expected QoS adaptation pattern is communicated to the RAN node that serves the UE. In one embodiment, the method includes applying QoS flow remapping for the QoS flow of the UE based on the sequence of QoS profiles of the expected QoS adaptation pattern at the RAN node. In various embodiments, the expected QoS adaptation pattern is communicated to an application client executing on the UE.

In certain embodiments, the method includes updating local QoS policies on the UE in response to receiving the expected QoS adaptation pattern, wherein updating the local QoS policies comprises at least one of sending a PDU session modification request to an AMF/SMF that includes the QoS expected adaptation pattern to indicate a change of the QoS profiles for the QoS flow and sending the expected QoS adaptation pattern to a RAN node for QoS adaptation using the one or more QoS profiles of the expected QoS adaptation pattern.

In one embodiment, the expected QoS adaptation pattern is determined by an edge enabler server and is communicated to an edge enabler client executing on the UE. In certain embodiments, the UE sends the expected QoS adaptation pattern to a serving RAN node in response to the expected QoS adaptation pattern affecting a radio resource configuration and/or allocation.

In some embodiments, the UE sends the expected QoS adaptation pattern to a serving core network node in response to the expected QoS adaptation pattern affecting a PDU-Session-to-QoS-Profile mapping. In one embodiment, the one or more characteristics of the UE comprises UE perception data, the UE perception data comprising parameters indicative of the environment information as perceived by the UE along its expected route.

Disclosed herein is a first apparatus for edge enabled AI/ML-assisted QoS profile configuration. The first apparatus may be implemented by a RAN control entity, the AI function 151, the Edge P-QoS application 185, and/or a network equipment apparatus 600.

The first apparatus includes a receiver that receives at least one of actual and expected characteristics of a user equipment (“UE”) that describes a context of the UE and obtains a data analytics model describing at least one expected network condition of a radio access network (“RAN”) node based on the characteristics of the UE. The first apparatus includes a processor that determines an expected QoS adaptation pattern, based on the obtained data analytics model, at a mobile edge computing entity within a service area of the UE, the QoS adaptation pattern comprising a sequence of QoS profiles to be associated with a QoS flow for the UE over a time interval. The first apparatus includes a transmitter that communicates the expected QoS adaptation pattern for the QoS flow of the UE to the UE and/or at least one network node associated with the QoS flow.

In one embodiment, the receiver receives a subscription request from the entity to be notified of the expected QoS adaptation pattern. In certain embodiments, the subscription request comprises a type of data analytics model to be used, types of QoS analytics to be used, and/or an expected accuracy and/or training configuration for the data analytics model.

In some embodiments, the receiver receives one or more QoS configuration parameters from a serving RAN node within the service area of an edge data network. In one embodiment, the QoS configuration parameters comprise a QoS flow ID, a list of QoS profiles, priorities of QoS profiles, a geographical area, a time validity, a hysteresis threshold, and/or an S-NSSAI.

In certain embodiments, the receiver receives one or more radio parameters from a serving RAN node within the service area of an edge data network and enhancing the data analytics model with up-to-date channel information. In one embodiment, the one or more radio parameters comprise CSI measurements, radio resource management (“RRM”) measurements, radio link monitoring (“RLM”) measurements, radio resource control (“RRC”) parameters for a user, RRC parameters for a cell, RRM function outputs, parameters for a network slice, and/or UE context parameters.

In one embodiment, the data analytics model comprises an artificial intelligence model that is trained for expected RAN resource conditions and/or expected wireless backhaul resource conditions. In various embodiments, the one or more characteristics of the UE comprises a UE mobility pattern, the UE mobility pattern comprising at least one of the following parameters: a sequence of location coordinates for the UE for different time instances within a given area, a sequence of cell handovers for different time instances within a given area, an estimated trajectory of the UE, an HD location map, and an expected speed/velocity of the UE.

In certain embodiments, the expected QoS adaptation pattern indicates one of a current QoS profile is expected to remain the same for a particular time duration within the time interval and/or geographical area; a current QoS profile is expected to downgrade to a different QoS profile a particular time instance, within the time interval, for a particular time duration and/or geographical area; and a current QoS profile is expected to upgrade to a different QoS profile at a particular time instance, within the time interval, for a particular time duration and/or geographical area.

In some embodiments, the expected QoS adaptation pattern is communicated to the RAN node that serves the UE. In various embodiments, the processor applies QoS flow remapping for the QoS flow of the UE based on the sequence of QoS profiles of the expected QoS adaptation pattern at the RAN node. In one embodiment, the expected QoS adaptation pattern is communicated to an application client executing on the UE.

In certain embodiments, the processor updates local QoS policies on the UE in response to receiving the expected QoS adaptation pattern, wherein updating the local QoS policies comprises at least one of sending a PDU session modification request to an AMF/SMF that includes the QoS expected adaptation pattern to indicate a change of the QoS profiles for the QoS flow; and sending the expected QoS adaptation pattern to a RAN node for QoS adaptation using the one or more QoS profiles of the expected QoS adaptation pattern.

In one embodiment, the expected QoS adaptation pattern is determined by an edge enabler server and is communicated to an edge enabler client executing on the UE. In certain embodiments, the UE sends the expected QoS adaptation pattern to a serving RAN node in response to the expected QoS adaptation pattern affecting a radio resource configuration and/or allocation.

In various embodiments, the UE sends the expected QoS adaptation pattern to a serving core network node in response to the expected QoS adaptation pattern affecting a PDU-Session-to-QoS-Profile mapping. In one embodiment, the one or more characteristics of the UE comprises UE perception data, the UE perception data comprising parameters indicative of the environment information as perceived by the UE along its expected route.

Disclosed herein is a second method for edge enabled AI/ML-assisted QoS profile configuration. The method may be performed by a user equipment apparatus 500. The method includes sending at least one of actual and expected characteristics of a user equipment (“UE”) that describes a context of the UE. The method includes receiving an expected QoS adaptation pattern at the UE, the expected QoS adaptation pattern generated by a data analytics model based on the at least one of actual and expected characteristics of the UE, the expected QoS adaptation pattern comprising a sequence of QoS profiles to be associated with a QoS flow for the UE over a time interval. The method includes updating at least one local QoS policy at the communication part of the UE based on the expected QoS adaptation pattern. The method includes at least one of sending a packet data unit (“PDU”) session modification request to a core network, the request comprising the expected QoS adaption pattern and sending the expected QoS adaptation pattern to a gNB over radio resource control (“RRC”).

In one embodiment, an edge enabler client (“EEC”) executing on the UE interacts with at least one of a non-access stratum (“NAS”) layer and an access stratum (“AS”) layer of the UE for sending the expected QoS adaptation pattern. In various embodiments, the method includes, prior to sending the at least one of actual and expected characteristics of the UE, establishing a session between the EEC and an edge enabler server (“EES”), the EES authorized to provide the expected QoS adaptation pattern, and receiving configuration information from an edge configuration server (“ECS”) for triggering an action in response to receiving the expected QoS adaptation pattern.

Disclosed herein is a user equipment apparatus for edge enabled AI/ML-assisted QoS profile configuration. The user equipment apparatus includes a transmitter that sends at least one of actual and expected characteristics of a user equipment (“UE”) that describes a context of the UE and a receiver that receives a QoS adaptation pattern at the UE, the QoS adaptation pattern generated by a data analytics model based on the at least one of actual and expected characteristics of the UE. The QoS adaptation pattern includes a sequence of QoS profiles to be associated with a QoS flow for the UE over a time interval. At least one local QoS policy is updated at the communication part of the UE based on the QoS adaptation pattern and the transmitter sends a packet data unit (“PDU”) session modification request to the core network that includes the QoS adaption pattern, and sends the QoS adaptation pattern to a gNB over radio resource control (“RRC”).

In one embodiment, the user equipment apparatus includes an edge enabler client (“EEC”) executing on the UE interacts with at least one of a non-access stratum (“NAS”) layer and an access stratum (“AS”) layer of the UE for sending the expected QoS adaptation pattern. In one embodiment, prior to sending the at least one of actual and expected characteristics of the UE, a session between the EEC and an edge enabler server (“EES”) is established, the EES authorized to provide the expected QoS adaptation pattern, and configuration information is received from an edge configuration server (“ECS”) for triggering an action in response to receiving the expected QoS adaptation pattern.

Disclosed herein is a third method for edge enabled AI/ML-assisted QoS profile configuration. The method may be performed by a network equipment apparatus 600. The method includes sending a subscription request to be notified of an expected QoS adaptation pattern. The method includes sending at least one of actual and expected characteristics of a user equipment (“UE”) that describes a context of the UE. The method includes receiving the expected QoS adaptation pattern, which is generated using a data analytics model based on the at least one of actual and expected characteristics of the UE, the expected QoS adaptation pattern comprising a sequence of QoS profiles to be associated with a QoS flow for the UE over a time interval. The method includes sending an indication of the QoS adaptation pattern to a Session Management Function (“SMF”), the indication comprising a QoS profile from the QoS adaptation pattern for changing the QoS flow for the UE.

In certain embodiments, the method includes receiving the expected QoS adaptation pattern from a mobile edge computing entity. The method, in one embodiment, includes receiving the expected QoS adaptation pattern from the UE.

Disclosed herein is a network equipment apparatus of a radio access network for edge enabled AI/ML-assisted QoS profile configuration. The network equipment apparatus includes a transmitter that sends a subscription request from to be notified of an expected QoS adaptation pattern and at least one of actual and expected characteristics of a user equipment (“UE”) that describes a context of the UE. The network equipment apparatus includes a receiver that receives the expected QoS adaptation pattern, which is generated using a data analytics model based on the at least one of actual and expected characteristics of the UE. The QoS adaptation pattern includes a sequence of QoS profiles to be associated with a QoS flow for the UE over a time interval. An indication of the QoS adaptation pattern is sent to a Session Management Function (“SMF”). The indication comprising a QoS profile from the QoS adaptation pattern for changing the QoS flow for the UE.

In one embodiment, the receiver receives the expected QoS adaptation pattern from a mobile edge computing entity. In further embodiments, the receiver receives the expected QoS adaptation pattern from the UE.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus, comprising:
a processor; and
a memory coupled to the processor, the memory comprising instructions executable by the processor to cause the apparatus to:
receive at least one of actual and expected characteristics of a user equipment (“UE”) that describes a context of the UE;
obtain a data analytics model describing at least one expected network condition of a radio access network (“RAN”) node based on the characteristics of the UE;
determine an expected QoS adaptation pattern, based on the obtained data analytics model, at a mobile edge computing entity within a service area of the UE, the QoS adaptation pattern comprising a sequence of QoS profiles to be associated with a QoS flow for the UE over a time interval; and
communicate the expected QoS adaptation pattern for the QoS flow of the UE to the UE and/or at least one network node associated with the QoS flow.

2. The apparatus of claim 1, wherein the instructions are further executable by the processor to cause the apparatus to receive a subscription request from the entity to be notified of the expected QoS adaptation pattern.

3. The apparatus of claim 2, wherein the subscription request comprises a type of data analytics model to be used, types of QoS analytics to be used, and/or an expected accuracy and/or training configuration for the data analytics model.

4. The apparatus of claim 1, wherein the instructions are further executable by the processor to cause the apparatus to receive one or more QoS configuration parameters from a serving RAN node within the service area of an edge data network.

5. The apparatus of claim 4, wherein the QoS configuration parameters comprise a QoS flow ID, a list of QoS profiles, priorities of QoS profiles, a geographical area, a time validity, a hysteresis threshold, and/or an S-NSSAI.

6. The apparatus of claim 1, wherein the instructions are further executable by the processor to cause the apparatus to receive one or more radio parameters from a serving RAN node within the service area of an edge data network and enhancing the data analytics model with up-to-date channel information.

7. The apparatus of claim 6, wherein the one or more radio parameters comprise CSI measurements, radio resource management (“RRM”) measurements, radio link monitoring (“RLM”) measurements, radio resource control (“RRC”) parameters for a user, RRC parameters for a cell, RRM function outputs, parameters for a network slice, and/or UE context parameters.

8. The apparatus of claim 1, wherein the data analytics model comprises an artificial intelligence model that is trained for expected RAN resource conditions and/or expected wireless backhaul resource conditions.

9. The apparatus of claim 1, wherein the one or more characteristics of the UE comprises a UE mobility pattern, the UE mobility pattern comprising at least one of the following parameters: a sequence of location coordinates for the UE for different time instances within a given area, a sequence of cell handovers for different time instances within a given area, an estimated trajectory of the UE, an HD location map, and an expected speed/velocity of the UE.

10. The apparatus of claim 1, wherein the expected QoS adaptation pattern indicates one of:
a current QoS profile is expected to remain the same for a particular time duration within the time interval and/or geographical area;
a current QoS profile is expected to downgrade to a different QoS profile at a particular time instance, within the time interval, for a particular time duration and/or geographical area; and
a current QoS profile is expected to upgrade to a different QoS profile at a particular time instance, within the time interval, for a particular time duration and/or geographical area.

11. The apparatus of claim 1, wherein the expected QoS adaptation pattern is communicated to the RAN node that serves the UE.

12. The apparatus of claim 11, wherein the instructions are further executable by the processor to cause the apparatus to apply QoS flow remapping for the QoS flow of the UE based on the sequence of QoS profiles of the expected QoS adaptation pattern at the RAN node.

13. The apparatus of claim 1, wherein the expected QoS adaptation pattern is communicated to an application client executing on the UE.

14. The apparatus of claim 13, wherein the instructions are further executable by the processor to cause the apparatus to update local QoS policies on the UE in response to receiving the expected QoS adaptation pattern, wherein updating the local QoS policies comprises at least one of:
sending a PDU session modification request to an AMF/SMF that includes the QoS expected adaptation pattern to indicate a change of the QoS profiles for the QoS flow; and
sending the expected QoS adaptation pattern to a RAN node for QoS adaptation using the one or more QoS profiles of the expected QoS adaptation pattern.

15. The apparatus of claim 1, wherein the expected QoS adaptation pattern is determined by an edge enabler server and is communicated to an edge enabler client executing on the UE.

16. The apparatus of claim 15, wherein the UE sends the expected QoS adaptation pattern to a serving RAN node in response to the expected QoS adaptation pattern affecting a radio resource configuration and/or allocation.

17. The apparatus of claim 15, wherein the UE sends the expected QoS adaptation pattern to a serving core network node in response to the expected QoS adaptation pattern affecting a PDU-Session-to-QoS-Profile mapping.

18. The apparatus of claim 1, wherein the one or more characteristics of the UE comprises UE perception data, the UE perception data comprising parameters indicative of environment information as perceived by the UE along its expected route.

19. An apparatus comprising:
a processor; and
a memory coupled to the processor, the memory comprising instructions executable by the processor to cause the apparatus to:
send at least one of actual and expected characteristics of a user equipment (“UE”) that describes a context of the UE;
receive an expected QoS adaptation pattern at the UE, the expected QoS adaptation pattern generated by a data analytics model based on the at least one of actual and expected characteristics of the UE, the expected QoS adaptation pattern comprising a sequence of QoS profiles to be associated with a QoS flow for the UE over a time interval;
update at least one local QoS policy at a communication part of the UE based on the expected QoS adaptation pattern; and
at least one of:
send a packet data unit (“PDU”) session modification request to a core network, the request comprising the expected QoS adaption pattern; and
send the expected QoS adaptation pattern to a gNB over radio resource control (“RRC”).

20. An apparatus comprising:
a processor; and
a memory coupled to the processor, the memory comprising instructions executable by the processor to cause the apparatus to:
send a subscription request to be notified of an expected QoS adaptation pattern;
send at least one of actual and expected characteristics of a user equipment (“UE”) that describes a context of the UE;
receive the expected QoS adaptation pattern, which is generated using a data analytics model based on the at least one of actual and expected characteristics of the UE, the expected QoS adaptation pattern comprising a sequence of QoS profiles to be associated with a QoS flow for the UE over a time interval; and
send an indication of the QoS adaptation pattern to a Session Management Function (“SMF”), the indication comprising a QoS profile from the QoS adaptation pattern for changing the QoS flow for the UE.
